(19) United States
(12) Patent Application Publication
(10) Pub. No.: US 2008/0313210 A1
(43) Pub. Date: Dec. 18, 2008

(54) Content Publishing Customized to Capabilities of Device

(75) Inventors: Howard L. Cooperstein, Menlo Park, CA (US); Joe Mark Montgomery, San Francisco, CA (US); David R. Anderson, Saratoga, CA (US); Darrin Eugene Eide, Bellevue, WA (US); Jianwen Wang, San Jose, CA (US); Regis G. Charton, Mountain View, CA (US); Elena N. Demchuk, San Jose, CA (US); Stephane A. Karoubi, Mountain View, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/764,173

(22) Filed: Jun. 15, 2007

(51) Int. Cl. G06F 17/00; G06F 15/00

(52) U.S. Cl. 707/102; 707/E17.005

(57) ABSTRACT

Aspects of the subject matter described herein relate to customizing content to the capabilities of a device. In aspects, an editor uses an editorial tool to specify criteria applicable to content. The criteria include rules to apply in generating content based on quantized capabilities of devices. A publishing component that receives a request for content first detects the capabilities of the requesting device. Then, the publishing component classifies the capabilities of the device and applies the criteria to the classifications in customizing content to deliver to the device.

### BACKGROUND

Cell phones and other mobile devices have varying capabilities. Some mobile devices have relatively limited memory for displaying content while other mobile devices have significantly more memory for displaying content. Furthermore, mobile devices greatly vary in their screen size both in width and height as well as number of pixels. Taking advantage of this diversity of capabilities to provide an optimum viewing experience is a challenge for publishers that provide content to mobile devices.

### SUMMARY

Briefly, aspects of the subject matter described herein relate to customizing content to the capabilities of a device. In aspects, an editor uses an editorial tool to specify criteria applicable to content. The criteria include rules to apply in generating content based on quantized capabilities of devices. A publishing component that receives a request for content first detects the capabilities of the requesting device. Then, the publishing component classifies the capabilities of the device and applies the criteria to the classifications in customizing content to deliver to the device.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary mobile device into which aspects of the subject matter described herein may be incorporated;

FIG. 2 is a block diagram that represents an exemplary environment in which aspects of the subject matter described herein may be implemented;

FIG. 3 illustrates some elements of an exemplary user interface that may be presented by an editorial tool in accordance with aspects of the subject matter described herein;

FIG. 4 illustrates an exemplary control that may be presented by an editorial tool to indicate how many items may be displayed from a content module in accordance with aspects of the subject matter described herein;

FIG. 5 illustrates an exemplary control that may be presented by an editorial tool to indicate how many columns a content module may display based on display width in accordance with aspects of the subject matter described herein;

FIG. 6 is a block diagram that represents an exemplary server configured to operate in accordance with aspects of the subject matter described herein;

FIG. 7 is a flow diagram that generally represents exemplary actions that may occur in conjunction with using an editorial tool in accordance with aspects of the subject matter described herein; and

FIG. 8 is a flow diagram that generally represents exemplary actions that may occur on a publishing server in accordance with aspects of the subject matter described herein.

### DETAILED DESCRIPTION

### Exemplary Operating Environment

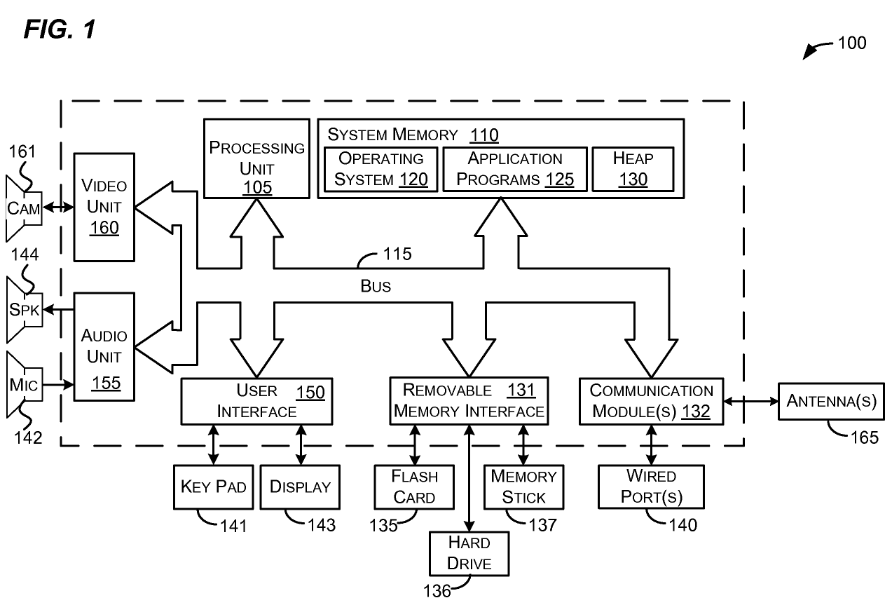

FIG. 1 illustrates an example of a suitable mobile device 100 on which aspects of the subject matter described herein may be implemented. The mobile device 100 is only one example of a device and is not intended to suggest any limitation as to the scope of use or functionality of aspects of the subject matter described herein. Neither should the mobile device 100 be interpreted as having any dependency or requirement relating to any one or combination of components illustrated in the exemplary mobile device 100.

With reference to FIG. 1, an exemplary device for implementing aspects of the subject matter described herein includes a mobile device 100. In some embodiments, the mobile device 100 comprises a cell phone, a handheld device that allows voice communications with others, some other voice communications device, or the like. In these embodiments, the mobile device 100 may be equipped with a camera for taking pictures, although this may not be required in other embodiments. In other embodiments, the mobile device 100 comprises a personal digital assistant (PDA), hand-held gaming device, notebook computer, printer, appliance including a set-top, media center, or other appliance, other mobile devices, or the like. In yet other embodiments, the mobile device 100 may comprise devices that are generally considered non-mobile such as personal computers, servers, or the like.

Components of the mobile device 100 may include, but are not limited to, a processing unit 105, system memory 110, and a bus 115 that couples various system components including the system memory 110 to the processing unit 105. The bus 115 may include any of several types of bus structures including a memory bus, memory controller, a peripheral bus, and a local bus using any of a variety of bus architectures, and the like. The bus 115 allows data to be transmitted between various components of the mobile device 100.

The mobile device 100 may include a variety of computer-readable media. Computer-readable media can be any available media that can be accessed by the mobile device 100 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 100.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, WiFi, WiMAX, and other wireless media. Combinations of any of the above should also be included within the scope of computer-readable media.

The system memory 110 includes computer storage media in the form of volatile and/or nonvolatile memory and may include read only memory (ROM) and random access memory (RAM). On a mobile device such as a cell phone, operating system code 120 is sometimes included in ROM although, in other embodiments, this is not required. Similarly, application programs 125 are often placed in RAM although again, in other embodiments, application programs may be placed in ROM or in other computer-readable memory. The heap 130 provides memory for state associated with the operating system 120 and the application programs 125. For example, the operating system 120 and application programs 125 may store variables and data structures in the heap 130 during their operations.

The mobile device 100 may also include other removable/non-removable, volatile/nonvolatile memory. By way of example, FIG. 1 illustrates a flash card 135, a hard disk drive 136, and a memory stick 137. The hard disk drive 136 may be miniaturized to fit in a memory slot, for example. The mobile device 100 may interface with these types of non-volatile removable memory via a removable memory interface 131, or may be connected via a universal serial bus (USB), IEEE 1394, one or more of the wired port(s) 140, or antenna(s) 165. In these embodiments, the removable memory devices 135-137 may interface with the mobile device via the communications module(s) 132. In some embodiments, not all of these types of memory may be included on a single mobile device. In other embodiments, one or more of these and other types of removable memory may be included on a single mobile device.

In some embodiments, the hard disk drive 136 may be connected in such a way as to be more permanently attached to the mobile device 100. For example, the hard disk drive 136 may be connected to an interface such as parallel advanced technology attachment (PATA), serial advanced technology attachment (SATA) or otherwise, which may be connected to the bus 115. In such embodiments, removing the hard drive may involve removing a cover of the mobile device 100 and removing screws or other fasteners that connect the hard drive 136 to support structures within the mobile device 100.

The removable memory devices 135-137 and their associated computer storage media, discussed above and illustrated in FIG. 1, provide storage of computer-readable instructions, program modules, data structures, and other data for the mobile device 100. For example, the removable memory device 135-137 may store images taken by the mobile device 100, voice recordings, contact information, programs, data for the programs and so forth.

A user may enter commands and information into the mobile device 100 through input devices such as a key pad 141 and the microphone 142. In some embodiments, the display 143 may be touch-sensitive screen and may allow a user to enter commands and information thereon. The key pad 141 and display 143 may be connected to the processing unit 105 through a user input interface 150 that is coupled to the bus 115, but may also be connected by other interface and bus structures, such as the communications module(s) 132 and wired port(s) 140.

A user may communicate with other users via speaking into the microphone 144 and via text messages that are entered on the key pad 141 or a touch sensitive display 143, for example. The audio unit 155 may provide electrical signals to drive the speaker 144 as well as receive and digitize audio signals received from the microphone 142.

The mobile device 100 may include a video unit 160 that provides signals to drive a camera 161. The video unit 160 may also receive images obtained by the camera 161 and provide these images to the processing unit 105 and/or memory included on the mobile device 100. The images obtained by the camera 161 may comprise video, one or more images that do not form a video, or some combination thereof.

The communication module(s) 132 may provide signals to and receive signals from one or more antenna(s) 165. One of the antenna(s) 165 may transmit and receive messages for a cell phone network. Another antenna may transmit and receive Bluetooth® messages. Yet another antenna may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 100 may connect to one or more remote devices. The remote devices may include a personal computer, a server, a router, a network PC, a cell phone, a peer device or other common network node, and typically includes many or all of the elements described above relative to the mobile device 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Content Publishing

As mentioned previously, mobile devices have varying capabilities. Some cell phones, for example, only have 10K of memory devoted to rendering pages for display. Other cell phones may have 300K devoted to rendering pages for display. The width and height of the displays may also vary greatly. Some cell phones are capable of receiving content in a variety of formats including Hypertext Markup Language (HTML), Extensible Markup Language (XML), Extensible HyperText Markup Language (XHTML), Wireless Markup Language (WML), and so forth. Other cell phones may have a very limited capability with respect to formats they understand.

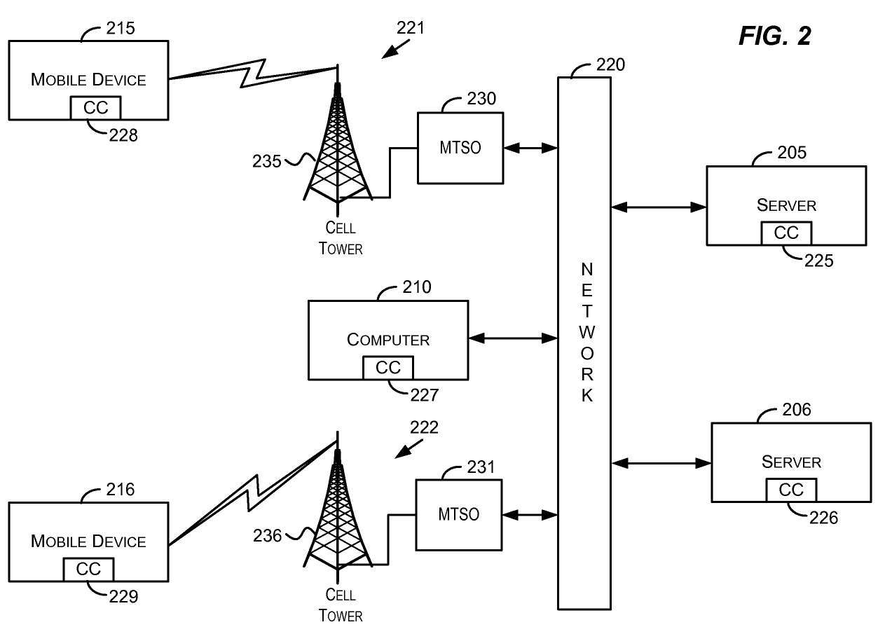

FIG. 2 is a block diagram that represents an exemplary environment in which aspects of the subject matter described herein may be implemented. The environment includes servers 205-206, computer 210, and mobile devices 215-216 (hereinafter sometimes collectively referred to as the entities) and may include other components (not shown). The entities may communicate with each other via various networks including intra- and inter-office networks, telephone lines, the network 220, cell phone networks 221 and 222, other wireless and wired networks, and the like. In one embodiment, the network 215 may comprise the Internet.

The cell phone networks 221 and 222 may include mobile telephone switching offices (MTSO) 230 and 231 respectively, for example, located within the cells generated by the cell towers 235 and 236, respectively. In other embodiments, the MTSOs may be located elsewhere. Each MTSO is a central switch that controls the operation of a cellular sub-system. In one embodiment, the MTSO may be implemented as a sophisticated computer system that monitors cellular calls, tracks the location of cellular devices (e.g. cellular-equipped vehicles, hand-carried mobile phones or cellular-equipped PDA devices, etc.) stationary or traveling in the system, arranges handoffs (e.g., between cells within the system), keeps track of billing information, and the like. Each MTSO may additionally function as a conduit to allow communications to and from the mobile devices 215 and 216 to others of the entities. In one embodiment, even with wireless devices, there may be no MTSOs 230 and 231.

The servers 205-206, computer 210, and the mobile devices 215-216 may include content components 226-229, respectively. The content components may comprise programs that allow the mobile devices 215-216 to view content authored and/or edited using the computer 210 and hosted by the servers 205-206. On the mobile device 215, for example, the content components 228 may comprise a web browser, client software, other software, and the like capable of requesting, receiving, and viewing content hosted on the servers 205-206. On the publishing side, the content components 225-226 may include a web server, authoring and/or editorial tool, related software, and the like.

Each of the servers 205-206 and the computer 210 may be implemented on one or more computers and there is no intention to limit the types of computers to those thought particularly as server computers or client computers. Indeed a computer that serves as a home computer may at times serve as a server computer and vice versa.

In one embodiment, the servers 205-206 may replicate content for scalability and redundancy, for example. In another embodiment, the servers 205-206 may each host a certain subset of available content. Users of the mobile devices 215-216 and the computer 210 may have accounts hosted on one or more of the servers 205-206.

In one embodiment, the mobile devices 215-216 may be implemented as described in conjunction with the mobile device 100 of FIG. 1. In one embodiment, the mobile devices 215-216 may comprise cell phones. In another embodiment, the mobile devices 215-216 may comprise notebook computers, other mobile devices, non-mobile devices, and the like as described previously in conjunction with FIG. 1.

Although the environment described above includes various numbers of each of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

The content hosted on the servers 205-206 may come from a variety of sources. In order to optimally display the content on various devices having various capabilities, the content components 225-226 on the servers 205-206 may include capability detectors. Based on information (e.g., request headers) in one or more communications with a requesting device, a capability detector may be able to detect various capabilities about the device including the amount of memory the device has to display a page, the screen dimensions of the device, the rendering languages the device supports, and so forth.

A capability detector may place detected capabilities of a requesting device in a property bag for use in rendering a page. In one embodiment, a property bag comprises a collection of properties. In another embodiment, a property bag comprises an ordered or unordered list. In some embodiments, a property bag may comprise any data structure capable of storing data about device capabilities.

The property bag may be passed to each component that is involved in building a page for the device. Each component may determine if and how to render its content based on the values contained in the property bag as described in more detail below.

The capability detector may also classify the capabilities of a device into quantized units. For example, instead of (or in addition to) indicating the memory a device has available to display a page by placing a value in the property bag, the memory display capability of a device may be classified into buckets and these classifications may be placed in the property bag. In one embodiment, devices having less than X amount of memory may be classified as “small” display memory. Devices having between X and Y amount of memory may be classified as “medium” display memory. Devices having greater than Y amount of memory may be classified as “large” display memory. The idea of classifying the capabilities into buckets is to reduce the complexity of customizing pages for varying device capabilities as devices with similar capabilities may be treated alike.

Furthermore, the values of X and Y may be configurable. For example, 10K or less display memory devices may be classified as “small” display memory. Later, it may be determined that 20K or less should be classified as a “small” display memory. The values used to classify device capabilities may be changed without re-coding the rendering components.

Although three buckets (e.g., “small,” “medium, ” and “large” have been indicated above), in other embodiments, there may be more, fewer, and/or different buckets into which a device's capabilities may be classified.

After it has determined a device's capabilities, a component of a server may place the detected capabilities and classifications in a property bag for use in rendering custom pages for the device based on the capabilities. The property bag may be passed to rendering components as needed so that each rendering component may make decisions about how to format content in a manner optimized for the requesting device. Content components on a server may use the same content to build each custom page but may select which portions of the content to display, how and where to display the portions, how to resize the content if needed, and so forth.

Content to be published to a mobile device may be grouped by content modules. A content module may include one or more pieces of content. Typically, the content included in a content module is related, but in some embodiments, this is not required. For example, a content module may include a picture, a heading, and one or more text lines. The picture, heading, and text lines may provide hyperlinks to additional content. Some other types of content a content module may include are stock market information, weather information, advertisements, popular searches, shopping information, breaking news, sports, other content, and the like. The above list is exemplary and it will be recognized that many other types of content may be placed into a content module without departing from the spirit or scope of aspects of the subject matter described herein.

A content module may be designed to display in a pre-defined area (sometimes called a “slot”). The area may have a preferred width and height and may be displayed in different places on a display. The content module may be associated with a rendering component that determines if and how to display the content in the content module based on the property bag and preferences indicated by the editorial tool.

Pages may be constructed by selecting one or more content modules to display, determining how and where the content modules are to be displayed, and generating code (e.g., HTML, XML, XHTML, WML, and so forth) that provides instructions for a Web browser or other content viewing component of a mobile device to display a page that includes content indicated by the generated code.

To expose an interface for specifying how to create pages that are customized to device capabilities, an editorial tool may be provided. The tool may allow an editor of an editing staff to indicate when a content module should provide code for a page sent to the device. Some criteria that may be used to make this determination may include whether the device has sufficient display memory, whether the device has a display with a sufficient width to display the content, and whether the device is capable of understanding a particular type of markup language.

For example, an editor may specify that a content module is not to be displayed if the device is classified as having small display memory. As another example, an editor may specify that a content module is not to be displayed if the device is classified as a small width display.

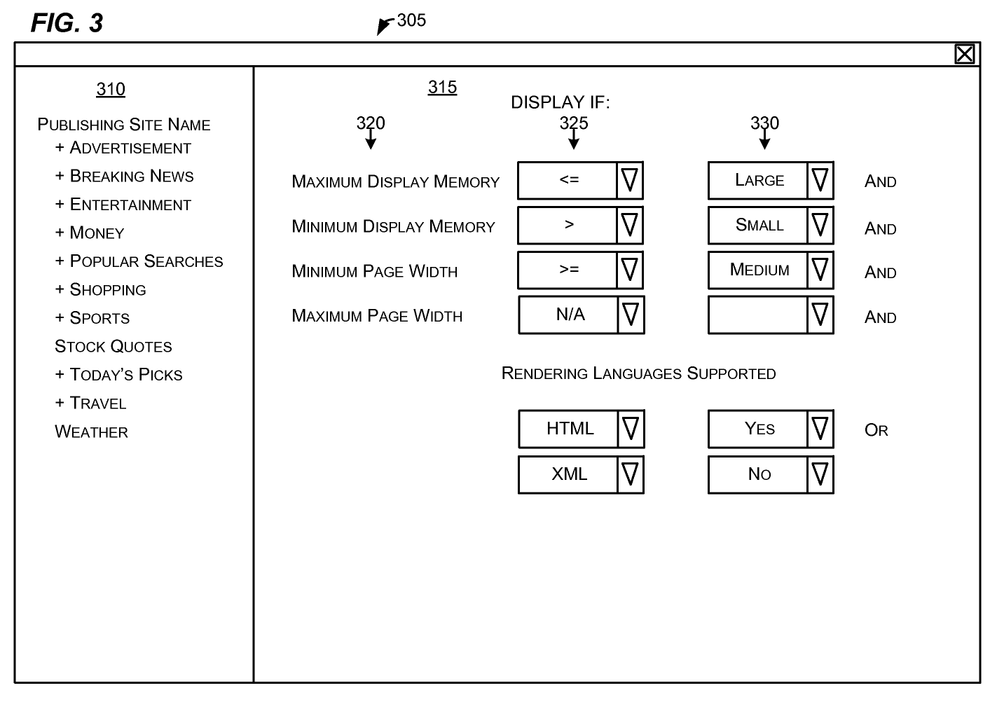

In one embodiment, the tool may provide a user interface that allows an editor to select a content module and then to indicate how content within the content module is to be customized based on device capabilities. FIG. 3 illustrates some elements of an exemplary user interface that may be presented by an editorial tool in accordance with aspects of the subject matter described herein. The editorial tool may comprise one or more web pages, a custom application having one or more input pages, a text-based command-line system allowing the editor to view, enter, and change values, or the like.

As illustrated, the user interface 305 includes a content module pane 310 and a criteria pane 315. The content module pane 310 includes a list of content modules. The content modules that have a “+” in front of their names may contain other content modules. Content modules that include other content modules are sometimes referred to herein as containment modules. The criteria applied to a containment module may apply to all content modules contained within the containment module unless overridden in the contained content module. For example, if an editor specified that the breaking news containment module is to be displayed regardless of page width or display memory, the editor could still specify that a content module within the breaking news containment module be or not be displayed based on page width or display memory.

The criteria pane 315 may include a list of capabilities that the mobile device needs to have in order for the associated content module to create rendering code to be sent to the mobile device. The criteria pane includes text 320 that identifies capabilities, operator fields 325, and value fields 330. Some exemplary operators include less than (<), less than or equal to (<=), equal to (=), not equal to (< >), greater than (>), greater than or equal to (>=), and not applicable (N/A).

Content associated with a content module should be displayed if it meets each of the criteria specified and is capable of being rendering in at least one of the rendering languages indicated. For example, as illustrated, the criteria specified in FIG. 3 would cause a content module to create rendering code for display on a mobile device if the maximum display memory was <= “large,” the minimum display memory was > “small,” the minimum page width was >= “medium,” and the device supported HTML.

Note that operator fields 325 and value fields 330 specified in the criteria pane 315 are exemplary and that other operator fields and value fields may be specified in other embodiments without departing from the spirit or scope of aspects of the subject matter described herein.

Also note that the rendering languages supported subsection of the criteria pane may allow an editor to select one or more rendering languages which will cause inclusion of the module. Thus, in one embodiment, an editor may have an option to add another rendering language to cause inclusion of the module or delete an existing rendering language associated with the module.

Furthermore, those skilled in the art will recognize that there may be many different ways of specifying the information indicated in FIG. 3. For example, in one embodiment, selecting a content module may cause representative content to be displayed in the pane 315. In this embodiment, a dialog box may be used to collect the information currently shown in the criteria pane 315. Many other forms of displaying and collecting this information may be used without departing from the spirit or scope of the subject matter described herein.

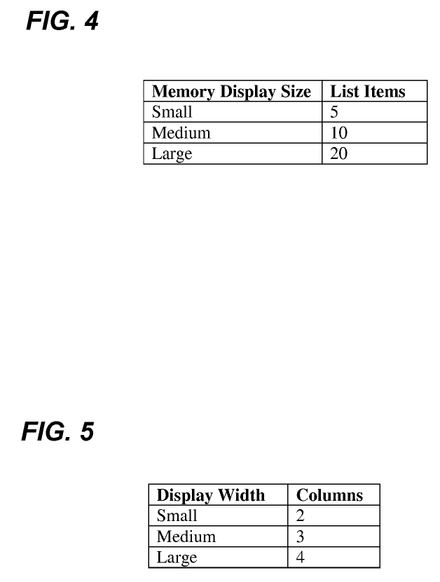

FIG. 4 illustrates an exemplary control that may be presented by an editorial tool to indicate how many items may be displayed from a content module in accordance with aspects of the subject matter described herein. For example, the editor may use the tool to indicate that content modules with up to 5 list items may be sent to devices with a small display memory while content modules with up to 20 list items may be sent to devices with large display memory. List items may include headings, images, abstracts, search results, other content, and the like. The number of categories and the list items per category may be changed as desired by an editor, for example.

A similar control may be provided to indicate how many items may be displayed on each page based on memory display size. The metadata obtained and updated by this control may be associated with an entire page instead of at the control or container level.

To limit the number of characters that may be displayed per page, yet another similar control may be provided. The control may include categories of display memory sizes and may indicate how many characters may be displayed in each category of display memory size.

FIG. 5 illustrates an exemplary control that may be presented by an editorial tool to indicate how many columns a content module may display based on display width in accordance with aspects of the subject matter described herein. Sometimes, content is displayed in multiple columns. To restrict the number of columns based on the display width, the control illustrated in FIG. 5 may be used. Again, the number of categories and the columns associated with each category may be changed may be changed as desired by an editor.

The controls shown in FIGS. 4 and 5 are exemplary and used to illustrate one mechanism for displaying and changing information for customized publishing based on device capabilities. It will be readily recognized, however, by those skilled in the art that many other controls may be used to obtain the information contained with FIGS. 4 and 5 without departing from the spirit or scope of the subject matter described herein.

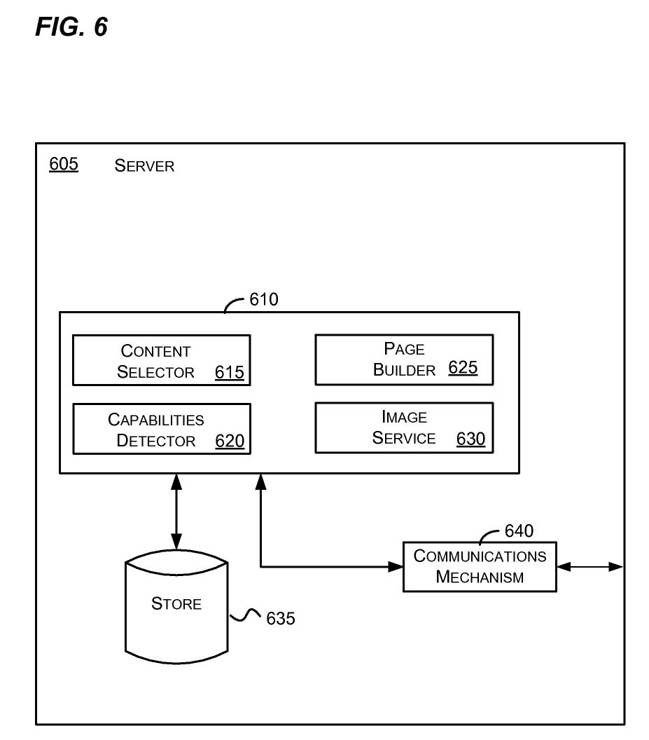

FIG. 6 is a block diagram that represents an exemplary server configured to operate in accordance with aspects of the subject matter described herein. The server 605 may include a publishing component 610, a store 635, and a communications mechanism 640. The publishing component 610 may include a content selector 615, a capabilities detector 620, a page builder 625, and an image service 630. The server 605 may correspond to one of the servers 205-206 of FIG. 2. The publishing component 610 corresponds to the content components 225-226 of FIG. 2.

The communications mechanism 640 allows the server 605 to receive configuration information from an editorial tool as well as receive and respond to requests for content. The communications mechanism 640 may be a network interface or adapter, modem, or any other mechanism for establishing communications, for example.

The store 635 is any storage media capable of storing content. The store 635 may also store publishing configuration information for pages, content containers, content modules, and so forth. The store may also be used to store properties included in a property bag. The store 635 may comprise a file system, database, volatile memory such as RAM, other storage, some combination of the above, and the like and may be distributed across multiple devices. The store 635 may be external or internal to the server 605.

The image service 630 may be used to scale images. Sometimes an image in its native size may be wider than the width of a display on a particular device. If displayed on the device, the image may be cropped or a user of the device may be required to scroll horizontally to see the entire image. Either of these results may be undesirable.

In one embodiment, when an image is larger than the width of a display, the page builder 625 may insert a link to the image service 630 for displaying the image. When the content browser of the device requests the image, the link refers the browser to the image service 630. The image service 630 may then use the property bag to determine the display width of the device and may scale the image to fit within the width of the device. If a percentage width has been specified, the image service 630 may scale the image to fit within the percentage width of the display. In scaling the image, the aspect ratio of the image may be preserved if desired.

Furthermore, if the image is in a format that the mobile device does not support, the image service 630 may convert the image into a format that the mobile device does support.

The editorial tool may provide an option for bypassing the image service 630. For example, images may be created specifically for a certain class of mobile device and may not need to be resized to fit on those devices. In this case, an editor may disable the image service for this content. In this case, the links may refer to the original images of the content. This may be done for performance reasons, for example.

The content selector 615 may determine whether to include content (e.g., from a content module or container) based on properties in a property bag as well as configuration data stored in the store. In one embodiment, the content selector 615 is part of the page builder 625; in other embodiments, the content selector 615 is separate from the page builder 625.

In operation, the server 605 may receive a web page request to provide a page to configure e-mail publishing for an account from a device (such as one of the devices 227-229 of FIG. 2). This request may be handled at least in part by the configuration logic 415 which may access the store 635 to obtain any previous settings and to save updated settings as appropriate. The configuration logic 415 may be instrumental in processing input from the user regarding the items identified in FIG. 3 and may also construct the e-mail addresses to which the user may send e-mail's to publish photos to the server 605.

Code (e.g., HTML, XML, XHTML, WML, and so forth) for sending to a device to display content may be created by the page builder 625. In one embodiment, the page builder 625 may examine content modules and may apply criteria to determine if and how to display the content therein. In another embodiment, the page builder 625 may have each content module generate its own code. In this embodiment, the page builder 625 may generate code that is outside of the content modules domain such as code that relates to page information.

The content components 610 illustrated in FIG. 6 are exemplary. In other embodiments, the components or functions thereof may be included in other components or further separated without departing from the spirit or scope of aspects of the subject matter described herein.

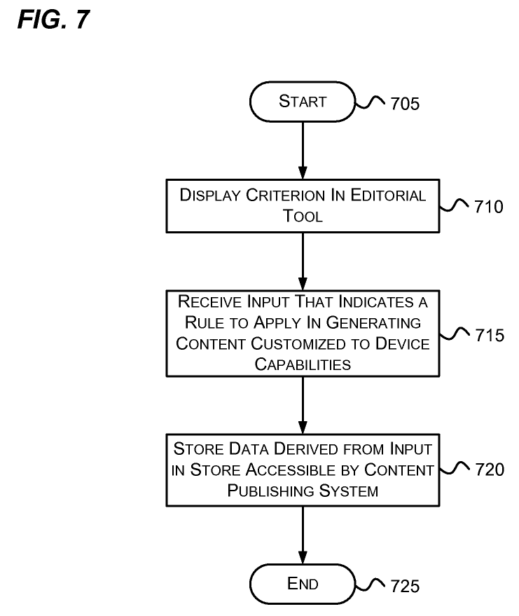

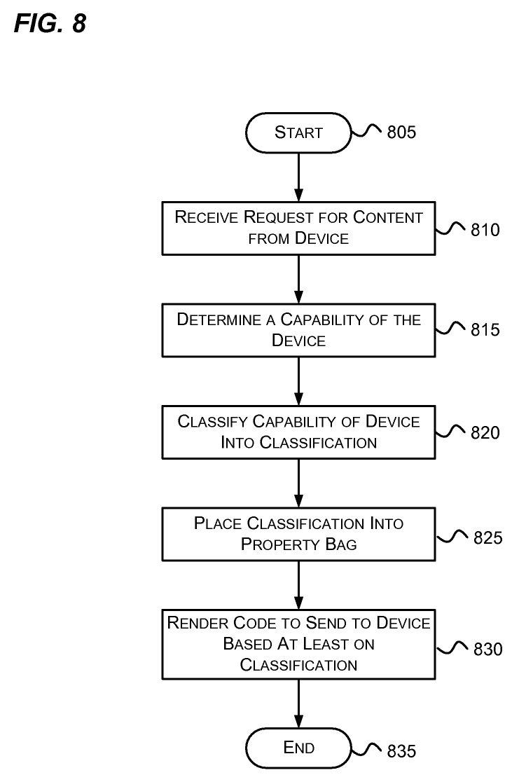

FIGS. 7-8 are flow diagrams that generally represent exemplary actions that may occur in accordance with aspects of the subject matter described herein. For simplicity of explanation, the methods described in conjunction with FIGS. 7-8 are depicted and described as a series of acts. It is to be understood and appreciated that the aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methods in accordance with aspects of the subject matter described herein. In addition, those skilled in the art will understand and appreciate that the methods could alternatively be represented as a series of interrelated states via a state diagram or as events.

FIG. 7 is a flow diagram that generally represents exemplary actions that may occur in conjunction with using an editorial tool in accordance with aspects of the subject matter described herein. At block 705, the actions begin.

At block 710, a criterion of a content publishing system is displayed. A criterion refers to a condition that is to be met for content to be displayed and/or formatted. For example, referring to FIG. 3, criteria related to display memory, page width, and rendering languages supported as illustrated. A criterion may indicate that no condition needs to be met. For example, a criterion may indicate not applicable.

At block 715, input is received that indicates a rule to apply in generating content customized to device capabilities. For example, referring to FIG. 3, a rule may indicate that content associated with a content module is to be published to a device only if the maximum display memory (e.g., memory available to display a page of content) is less than “large.”

At block 720, data derived from the input is stored in a store accessible by the content publishing system for use in creating rendering code to send to a requesting device. For example, referring to FIGS. 3 and 6, input received from the editorial tool 305 is stored in the store 635 for subsequent use by the content components 610 in creating content customized to capabilities of requesting devices.

At block 725, the actions end.

FIG. 8 is a flow diagram that generally represents exemplary actions that may occur on a publishing server in accordance with aspects of the subject matter described herein. At block 805, the actions begin.

At block 810, a request for content is received from a device. For example, referring to FIG. 215, the mobile device 215 sends a request for content to the server 205.

At block 815, capabilities of the device are determined. For example, referring to FIG. 6, the capabilities detector 620 detects the capabilities of the device as has been described previously.

At block 820, a capability of the device is classified into a classification. This refers to classifying a capability into a quantized amount (e.g., “small,” “medium,” “large,” or some other quantized amount). For example, if the requesting device only has 10K of display memory, the device may be classified as a “small” display memory device.

At block 825, the classification is placed into a property bag. For example, referring to FIG. 6, the capabilities detector 620 places the classification in a property bag included on the store 635.

At block 830, rendering code is created to send to the device. This rendering code is based at least on the classification. For example, referring to FIG. 6, the page builder 625 retrieves the property bag from the store 635 and uses it to create markup language code suitable for the requesting device. In doing this, the page builder 625 uses criteria previously entered by an editorial tool as applied to the classification. For example, if the criteria indicate that a content module is to be displayed if the display size is “small,” then the content module is displayed.

At block 835, the actions end.

As can be seen from the foregoing detailed description, aspects have been described related to customizing content to the capabilities of a device. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claim is:

1. A method implemented at least in part by a computer, the method comprising:
displaying a criterion of a content publishing system, the criterion affecting how content is customized for a variety of devices having different capabilities, the capabilities being quantized;
receiving input that indicates a rule to apply in generating content customized to quantized capabilities, the rule used at least in determining whether to include or format the content in rendering code sent to a device; and
storing data derived from the input in a store accessible to the content publishing system for use in creating the rendering code.

2. The method of claim 1, wherein the criterion corresponds to an amount of memory that a device has available to display a page of content.

3. The method of claim 1, wherein the criterion corresponds to a width of a display of a device.

4. The method of claim 1, wherein the criterion corresponds to a maximum number of columns to be displayed.

5. The method of claim 1, wherein the criterion corresponds to a maximum number of items to be displayed on a page.

6. The method of claim 1, wherein the criterion corresponds to a maximum number of items to be displayed from a content module.

7. The method of claim 1, wherein the criterion corresponds to a maximum number of characters to be displayed on a page.

8. The method of claim 1, wherein the criterion comprises a quantization of a capability of the devices and an operator.

9. The method of claim 8, wherein the quantization corresponds to one of large, medium, and small.

10. The method of claim 8, wherein the operator comprises one of <, <=, =, < >, >=, >, and not applicable.

11. The method of claim 1, wherein the rule indicates whether to include the content based on a rendering language supported by a device.

12. The method of claim 1, wherein the content is a single content module of a plurality of content modules to be published by the content publishing system, the content publishing system being capable of associating different criteria with each of the content modules, the criteria potentially affecting publishing of each of the content modules based on capabilities of a requesting device.

13. A computer-readable medium having computer-executable instructions, which when executed perform actions, comprising:
receiving a request for content from a device;
determining a capability of the device;
classifying the capability of the device into a classification;
placing the classification in a collection; and
rendering code to send to the device content based at least on the classification.

14. The method of claim 13, wherein the capability comprises memory available on the device to display a page of content.

15. The method of claim 13, wherein the capability comprises a screen dimension of a display of the device.

16. The method of claim 13, wherein the capability comprises a rendering language understood by the device.

17. The method of claim 13, wherein rendering code to send to the device content based at least on the classification comprises omitting content from the rendering code.

18. The method of claim 13, further comprising inserting links in the code that link to an image service, the image service having access to the collection, the image service operable to scale images to fit on a display of the device based on the classification.

19. In a computing environment, an apparatus, comprising:
a capabilities detector having logic to detect a capability of a requesting device and to classify the capability into a classification;
a store operable to store a criterion to apply in generating content customized to the classification; and
a page builder operable to obtain the criterion as well as the classification and to customize content based on the criterion and the classification.

20. The apparatus of claim 19, further comprising an image service operable to scale images based on a capability of the requesting device, wherein the page builder is further operable to insert links within rendering code sent to the requesting device, the links referring the requesting device to the image service.
